(19) United States
(12) Patent Application Publication
(10) Pub. No.: US 2021/0346136 A1
(43) Pub. Date: Nov. 11, 2021

(54) DENTURE BRUSHER

(71) Applicant: KAGOSHIMA SEIKI CO., LTD., Kirishima-shi (JP)

(72) Inventors: Hirofumi FUKUDOME, Kagoshima-shi (JP); Yukihiro YAMAMURA, Kirishima-shi (JP)

(21) Appl. No.: 17/265,173

(22) PCT Filed: May 14, 2019
(86) PCT No.: PCT/JP2019/019034

§ 371 Date: Feb. 1, 2021

(30) Foreign Application Priority Data
Aug. 17, 2018 (JP) 2018-153460

(51) Int. Cl. A61C 17/22; A61C 17/40; A46B 9/04

(52) U.S. Cl. CPC A61C 17/222; A46B 9/04; A61C 17/40

(57) ABSTRACT

A denture brush that includes a frame having a plurality of wall pieces disposed at an outer circumferential part of a flat plate-shaped base, and first bristle tufts are arrayed on the wall pieces, and second bristle tufts 6 are arrayed in a center region of the base, and third bristle tufts are arrayed on an outer circumferential side of the second bristle tufts. When the denture brush is not housed in a holder, the wall pieces are positioned radially along the outer circumferential part of the base so as to be horizontal with respect to the base. When the denture brush is housed in the holder, the wall pieces are supported by a wall surface of a denture-brush-housing portion of the holder, and are positioned so as to stand upright with respect to the base.

### TECHNICAL FIELD

The present invention relates to a denture brusher that is capable of thoroughly brushing a denture in a short time by a simple operation, that is capable of being easily cleaned, and that is excellent in operability.

### BACKGROUND ART

There are various devices produced to remove stains on dentures, and a device that uses ultrasonic waves or a device that uses a cleaning liquid can be mentioned as that example. With respect to the structure of such a device, a toothbrush-shaped structure described in Patent Literature 1, a brush placed in the shape of the letter U described in Patent Literature 2, and so on can be mentioned.

The present inventor has invented a denture brusher that is capable of thoroughly brushing a denture in a short time by a simple operation, and a technique relative to this denture brusher is described in Patent Literature 3.
Patent Literature 1: Japanese Published Utility Model Application No. H7-39568
Patent Literature 2: Japanese Patent No. 2787568
Patent Literature 3: Japanese Patent No. 5940749

### SUMMARY OF INVENTION

### Technical Problem

The present inventor has studied improvements to the invention disclosed by Patent Literature 3, and, as a result, it has been found that there is room for further improvements with respect to easy cleaning, and there is a possibility that operability can be improved.

The present invention has been made in consideration of these circumstances, and aims to provide a denture brusher that is capable of thoroughly brushing a denture in a short time by a simple operation, that is capable of being easily cleaned, and that is excellent in operability.

### Solution to Problem

To solve the problem mentioned above, in a denture brusher of the present invention including a denture brush that includes a frame composed of a flat plate-shaped base and a plurality of wall pieces disposed at an outer circumferential part of the base, first bristle tufts arrayed on the wall pieces, second bristle tufts arrayed in a center region of the base, and third bristle tufts arrayed on an outer circumferential side of the second bristle tufts and that has an openable/closable structure in which switching is performed between an open state in which the wall pieces are positioned radially along the outer circumferential part of the base so as to be horizontal with respect to the base and a closed state in which the wall pieces are positioned so as to stand upright with respect to the base, a holder whose surface on a side opposite to a bottom surface of the holder is open and in which a bottomed denture-brush-housing portion capable of housing the denture brush is formed, and a motor that drives the denture brush by an on-off operation of the switch, the denture brusher is characterized by further including a detection means that detects whether a denture that is a to-be-brushed part is set in the denture brush, wherein when the detection means detects that the denture has been set in the denture brush, the switch is turned on, and the motor is driven, whereas when the detection means detects that the denture is not set in the denture brush, the switch is turned off, and the motor stops being driven.

When a denture that is a to-be-brushed part is set in the denture brush in a state in which the denture brush has been housed in the holder, the first bristle tufts come into contact with the outside of the denture, and the second bristle tufts come into contact with the inside of the denture, and the third bristle tufts come into contact with a clenched part of the denture, and, as a result, the denture is brushed by the denture brush, and, in this state, the wall pieces are positioned so as to stand upright with respect to the base while being supported by a wall surface of the holder, and the first bristle tufts formed on the wall pieces are directed sidewardly.

However, in a state in which the denture brush is not housed in the holder, the wall pieces are positioned radially along the outer circumferential part of the base so as to be horizontal with respect to the base. Therefore, when the first bristle tufts are implanted, bristle implantation is easily performed because the wall pieces are positioned radially along the outer circumferential part of the base so as to be horizontal with respect to the base. Additionally, likewise, when the denture brusher is cleaned after being used, it is possible to wash away stains adhering to the denture and it is possible to easily perform cleaning because the wall pieces are positioned radially along the outer circumferential part of the base so as to be horizontal with respect to the base.

As thus described, the denture brush of the present invention reaches a closed state in which the wall pieces are supported by the wall surface of the holder and are positioned so as to stand upright with respect to the base in a state of having been housed in the holder, whereas the denture brush reaches an open state in which the wall pieces are positioned radially along the outer circumferential part of the base so as to be horizontal with respect to the base in a state of not being housed in the holder, and the denture brush has an openable/closable structure in which switching is performed between the open state and the closed state.

In the denture brush of the present invention, the base can have a structure in which a plurality of through-holes are formed in the base with intervals between the through-holes.

The through-holes passing through the base are formed, and therefore stains and drainage flow out through the through-holes when cleaning is performed in the open state, thus making it possible to raise cleaning efficiency.

The denture brusher of the present invention is characterized in that the denture brusher is composed of the denture brush of the present invention and the holder in which the denture brush is housed, and the denture brush is rotated while being driven by a motor disposed in the holder, and a denture that has been set in the denture brush is brushed.

The denture brush is rotated while being driven by the motor disposed in the holder, and a denture that has been set in the denture brush is brushed, and therefore it is possible to brush the denture without rotationally operating the denture with the hand. The motor is not necessarily required to be disposed in the holder, and may be provided as a component that is structurally independent of the holder.

The denture brusher of the present invention can be configured such that, when the denture brush is housed in the denture-brush-housing portion of the holder, a lower surface of the base of the denture brush comes into contact with an upper surface of the bottom of the denture-brush-housing portion of the holder, and a concave portion formed at the lower surface of the base of the denture brush and a convex portion formed at the upper surface of the bottom of the denture-brush-housing portion of the holder are fitted to each other.

The concave portion formed at the lower surface of the base of the denture brush and the convex portion formed at the upper surface of the bottom of the denture-brush-housing portion of the holder are fitted to each other, and therefore it is possible to strengthen contact between the base of the denture brush and the bottom surface of the denture-brush-housing portion of the holder, and it is possible to prevent the denture brush from running idle when the denture brush is rotated, thus making it possible to reliably rotate the denture brush.

The denture brusher of the present invention can be configured such that, when the denture brush is housed in the denture-brush-housing portion of the holder, a lower surface of the base of the denture brush comes into contact with an upper surface of the bottom of the denture-brush-housing portion of the holder, and a convex portion formed at the lower surface of the base of the denture brush and a concave portion formed at the upper surface of the bottom of the denture-brush-housing portion of the holder are fitted to each other.

The convex portion formed at the lower surface of the base of the denture brush and the concave portion formed at the upper surface of the bottom of the denture-brush-housing portion of the holder are fitted to each other, and therefore it is possible to strengthen contact between the base of the denture brush and the bottom surface of the denture-brush-housing portion of the holder, and it is possible to prevent the denture brush from running idle when the denture brush is rotated, thus making it possible to reliably rotate the denture brush.

The denture brusher of the present invention further includes a detection means that detects whether a denture is set in the denture brush, and the denture brusher can be configured such that, when the detection means detects that the denture has been set in the denture brush, the switch connected to the motor is turned on, and the denture brush is rotated while being driven by the motor, and, when the detection means detects that the denture is not set in the denture brush, the switch connected to the motor is turned off, and the denture brush stops being driven by the motor, and the denture brush stops being rotated.

The detection means and the switch operation mentioned above activate the denture brush only when a denture is brushed by the denture brush, and, when the use of the denture brusher is finished, the denture brusher is automatically stopped, hence making it possible to brush the denture safely and reasonably.

The denture brusher of the present invention can be configured such that the detection means includes a brush support that bears the denture brush, an elastically deformable body disposed above the switch, and a roller disposed between the brush support and the elastically deformable body, and, when the denture is set in the denture brush so that the brush support comes into contact with the roller, the roller presses the elastically deformable body, and, as a result, the elastically deformable body is bent, and pushes a switch head, and, as a result, the switch is turned on, and, when the brush support is detached from the roller, the roller returns to an original position so as to unbend the elastically deformable body, and the elastically deformable body is detached from the switch head, and, as a result, the switch is turned off.

The on/off of the switch is performed by the deformation and the restoration of the elastically deformable body, which depends on whether a denture is set in the denture brush, and therefore it is possible to perform the rotation and the stop of the denture brush with a simple configuration.

The denture brusher of the present invention can be configured such that the detection means includes the brush support that bears the denture brush, a first magnet disposed under the brush support, and a second magnet disposed between the first magnet and the switch, and the first magnet and the second magnet have magnetic properties of the same pole, and, when the denture is set in the denture brush so that the brush support comes into contact with the first magnet, the first magnet approaches the second magnet, and the second magnet pushes the switch head by a repulsive force caused by a magnetic force of the first magnet, and, as a result, the switch is turned on, and, when the brush support is detached from the first magnet so that the first magnet returns to an original position, the first magnet moves away from the second magnet, and the repulsive force against the second magnet is released, and the second magnet is detached from the switch head, and, as a result, the switch is turned off.

The on/off of the switch is performed by the action and the release of the repulsive force of the magnet, which depends on whether a denture is set in the denture brush, and therefore it is possible to perform the rotation and the stop of the denture brush in a non-contact manner, and it is possible to make a switch that is excellent in durability.

The denture brusher of the present invention can be configured such that a rotation pattern of the denture brush by the motor is formed so that large rotation in which normal rotation is made 180 degrees from a starting point, and then reverse rotation is made so as to return to the starting point and small rotation in which the normal rotation and the reverse rotation are repeatedly made under the condition that a rotation angle is less than 180 degrees are combined with each other.

The large rotation to brush the whole region of a denture and the small rotation to scrape out local stains are combined together, and, as a result, it is possible to scrub stains away in a wide region. Additionally, when switching is performed from the normal rotation to the reverse rotation, an operation to scrape out stains that have locally gathered is performed, and therefore it is possible to raise efficiency in scraping out stains per unit time by making the small rotation in which the normal rotation and the reverse rotation are repeatedly made at a small angle.

In the denture brusher of the present invention, the small rotation can be set so as to be repeatedly made in different intervals while a starting point of rotation and a switching position from the normal rotation to the reverse rotation are changed in each rotation.

It is possible to raise efficiency in scraping out stains in the whole region by setting the small rotation so as to be repeatedly made in different intervals.

In the denture brusher of the present invention, the holder can be configured to be supported and fixed by a support stand.

The holder is supported and fixed by the support stand, and therefore it is possible to use the holder by placing the holder on a table without grasping the holder with the hand.

### Advantageous Effects of Invention

According to the present invention, it is possible to realize a denture brusher that is capable of thoroughly brushing a denture in a short time by a simple operation, that is capable of being easily cleaned, and that is excellent in operability.

### BRIEF DESCRIPTION OF DRAWINGS

FIG. 1 is a view showing a denture brush being in an open state in which the denture brush is not housed in a holder;

FIG. 2 is a view showing the denture brush being in a state in which the denture brush is housed in the holder.

FIG. 3 is a view describing the holder that is a constituent of a denture brusher according to an embodiment of the present invention;

FIG. 4 is a view showing the shape of a bottom surface of a frame of the denture brush and the shape of a contact surface of a denture-brush-housing portion of the holder;

FIG. 5 is a view showing the shape of a bottom surface of a frame of the denture brush and the shape of a contact surface of a denture-brush-housing portion of the holder;

FIG. 6 is a view showing a detailed structure of a detection means;

FIG. 7 is a view showing a detailed structure of a detection means; and

FIG. 8 is a view showing a rotation pattern of the denture brush.

### DESCRIPTION OF EMBODIMENTS

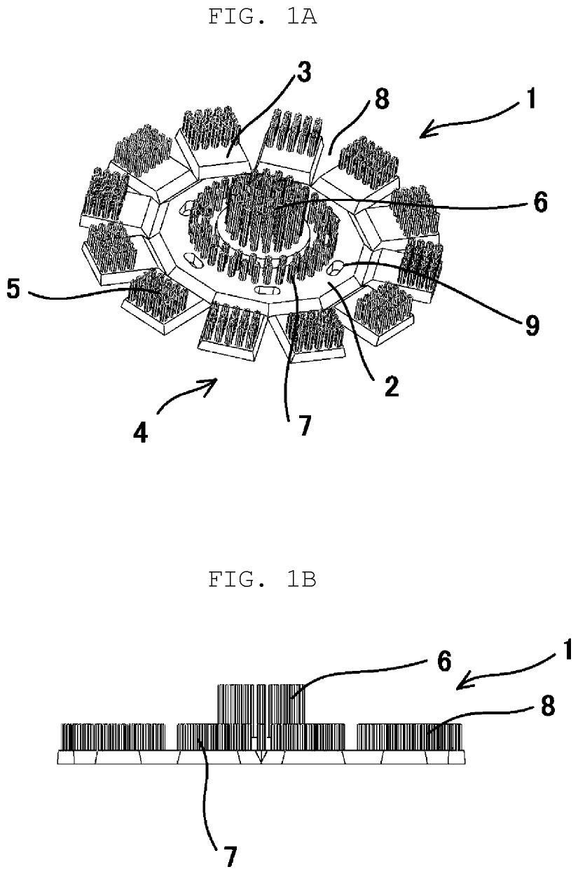

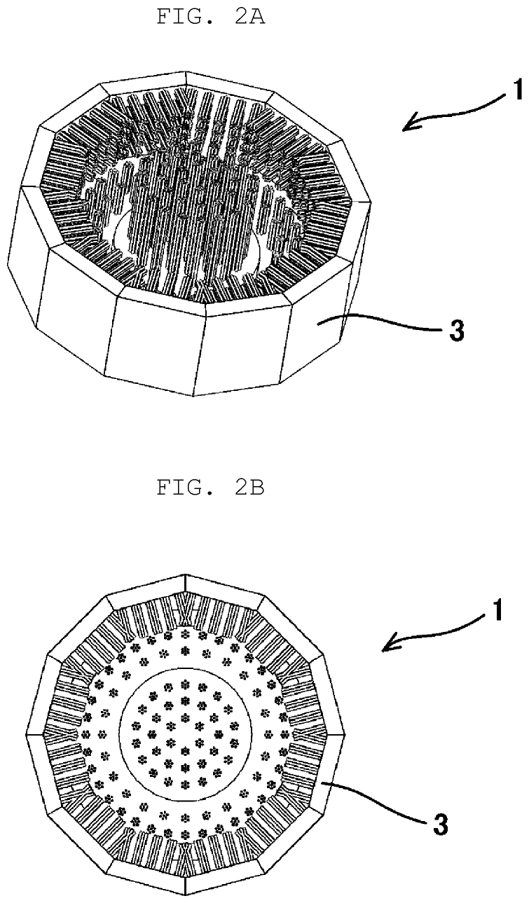

A denture brusher of the present invention will be hereinafter described on the basis of its embodiment. A structure of a denture brush according to an embodiment of the present invention is shown in FIG. 1 and FIG. 2. FIG. 1 shows an open state in which the denture brush is not housed in a holder, in which FIG. 1A is its perspective view, and FIG. 1B is its side view. FIG. 2 shows a state in which the denture brush is housed in the holder, in which FIG. 2A is its perspective view, and FIG. 2B is its plan view.

The denture brush 1 includes a frame 4 composed of a flat plate-shaped base 2 and a plurality of wall pieces 3 disposed at an outer circumferential part of the base 2. First bristle tufts 5 are arrayed on the wall pieces 3, and second bristle tufts 6 upwardly formed are arrayed in a center region of the base 2, and third bristle tufts 7 upwardly formed with a shorter length than the second bristle tufts 6 are arrayed on an outer circumferential side of the second bristle tufts 6.

When the denture brush 1 is in an open state in which the denture brush 1 is not housed in the holder 11, the wall pieces 3 are positioned radially along the outer circumferential part of the base 2 so as to be horizontal with respect to the base 2 as shown in FIG. 1. On the other hand, when the denture brush 1 is housed in the holder 11, the wall pieces 3 are supported by a wall surface of a denture-brush-housing portion 12 of the holder 11, and are positioned so as to stand upright with respect to the base 2 as shown in FIG. 2.

When the denture brush 1 is in the open state in which the denture brush 1 is not housed in the holder 11, void spaces 8 are formed between the wall pieces 3. On the other hand, when the denture brush 1 is in a state in which the denture brush 1 is housed in the holder 11, the wall pieces 3 are formed so that their respective ends come into contact with each other.

As thus described, an openable/closable structure in which switching between an open state and a closed state is performed is formed, and therefore it is possible to easily perform bristle implantation, and, when the denture brush 1 is cleaned after the denture brusher is used, it is possible to wash away stains adhering to the denture and it is possible to easily perform cleaning because the wall pieces 3 are positioned radially along the outer circumferential part of the base 2 so as to be horizontal with respect to the base 2. The openable/closable structure that enables the denture brush 1 to perform switching between an open state and a closed state is achievable by forming an incision at a connection part at which the wall pieces 3 are connected to the base 2 and by allowing this connection part to function as a hinge.

A plurality of through-holes 9 are formed in the base with intervals between the through-holes 9 on an outer circumferential side of the third bristle tufts 7. The shape, the number, and the size of the through-hole 9 are appropriately changeable depending on the situation. Likewise, the position at which the through-hole 9 is formed is appropriately changeable. The through-hole 9 is formed so as to pass through the base 2, and therefore stains and drainage flow out through the through-hole 9 when cleaning is performed in the open state, thus making it possible to raise cleaning efficiency.

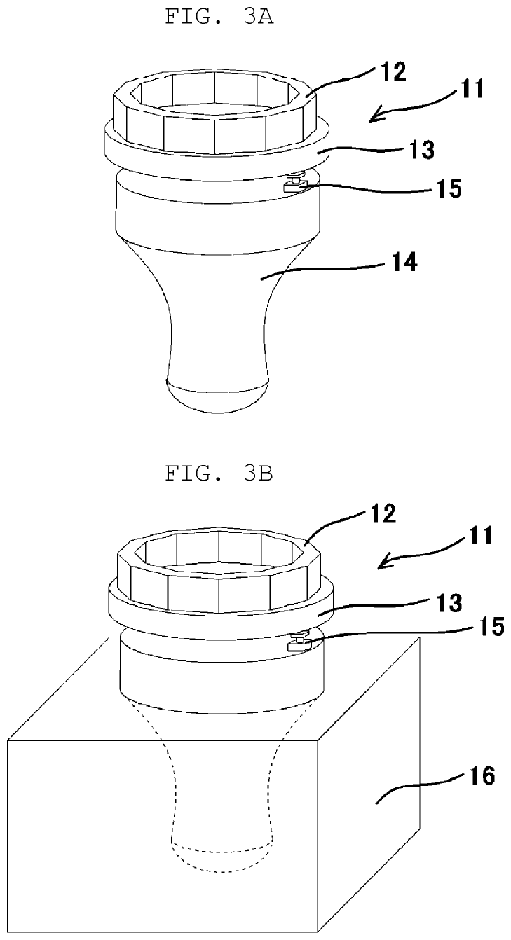

The holder 11 that is a constituent of the denture brusher according to the embodiment of the present invention will be described with reference to FIG. 3. The denture brusher is composed of the denture brush 1 described with reference to FIG. 1 and FIG. 2 and the holder 11 in which the denture brush 1 is housed. FIG. 3A shows the exterior of the holder 11.

The holder 11 is composed of the bottomed denture-brush-housing portion 12 that can house the denture brush 1, a brush support 13 positioned below the denture-brush-housing portion 12, and a holder body 14. A motor (not shown) is built into the holder body 14, and a switch 15 is disposed on an upper end of the holder body 14 at a position close to the brush support 13. When a denture is set in the denture brush 1 with a user's hand, the denture-brush-housing portion 12 and the denture brush 1 rotate together with each other while being driven by the motor around a rotational center that is a rotational shaft of the holder 11, and the denture set in the denture brush 1 is brushed.

Although FIG. 3A shows a usage mode in which the holder 11 is used with the hand, the holder 11 may be used in a state in which the holder body 14 is set in a support stand 16 as shown in FIG. 3B. The support stand 16 has a void space, and the holder body 14 is supported and fixed by the support stand 16 whose bottom surface is a flat surface by inserting the holder body 14 into the void space of the support stand 16, and therefore it is possible to use the holder 11 by placing the holder 11 on a table without grasping the holder 11 with the hand. Particularly when one hand cannot be used, there is high convenience. It is also possible to use the holder body 14 by forming a flat surface at a bottom surface part of the holder body 14 and placing the holder body 14 itself on a table.

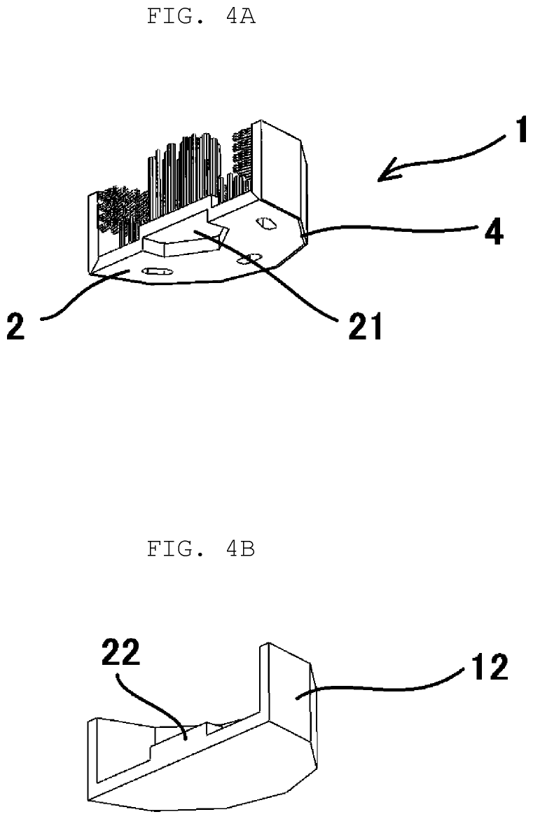

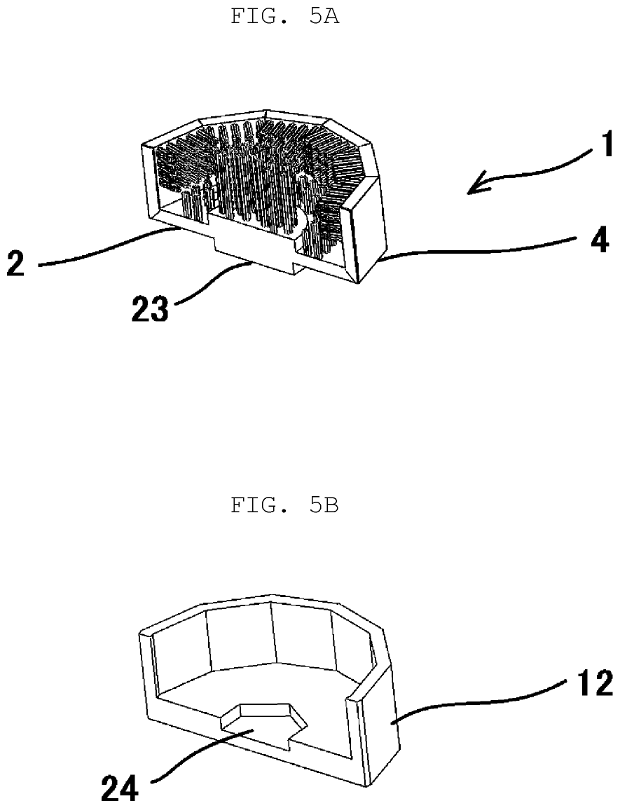

FIG. 4 and FIG. 5 each show the shape of a contact surface between the base 2 of the frame 4 of the denture brush 1 and a bottom of the denture-brush-housing portion 12 of the holder 11. For convenience of explanation, the denture brush 1 and the denture-brush-housing portion 12 are cut in an up-down direction as shown in each of FIGS. 4 and 5.

In FIG. 4, a lower surface of the base 2 of the denture brush 1 comes into contact with an upper surface of the bottom of the denture-brush-housing portion 12 when the frame 4 of the denture brush 1 is housed in the denture-brush-housing portion 12 of the holder 11. At that time, a concave portion 21 formed at the lower surface of the base 2 and a convex portion 22 formed at the upper surface of the bottom of the denture-brush-housing portion 12 are fitted to each other. The shape of the concave portion 21 and the shape of the convex portion 22 are not limited to those shown in FIG. 4. Additionally, in the concave portion 21 and the convex portion 22, their positions and their numbers are appropriately selectable.

In FIG. 5, a lower surface of the base 2 of the denture brush 1 comes into contact with an upper surface of the bottom of the denture-brush-housing portion 12 when the frame 4 of the denture brush 1 is housed in the denture-brush-housing portion 12 of the holder 11. At that time, a convex portion 23 formed at the lower surface of the base 2 and a concave portion 24 formed at the upper surface of the bottom of the denture-brush-housing portion 12 are fitted to each other. The shape of the convex portion 23 and the shape of the concave portion 24 are not limited to those shown in FIG. 5. Additionally, in the convex portion 23 and the concave portion 24, their positions and their numbers are appropriately selectable.

The structures shown in FIGS. 4 and 5 make it possible to strengthen contact between the lower surface of the base 2 and the upper surface of the bottom of the denture-brush-housing portion 12 of the holder 11, and make it possible to prevent the denture brush 1 from running idle when the denture brush 1 rotates in response to the rotation of the denture-brush-housing portion 12, thus making it possible to reliably rotate the denture brush 1.

The denture brusher of the present invention includes a detection means that detects whether a denture is set in the denture brush 1. When the detection means detects that a denture has been set in the denture brush 1, the switch 15 connected to the motor is turned on, and the denture brush 1 is driven and rotated by the motor. On the other hand, when the detection means detects that the denture is not set in the denture brush 1, the switch 15 connected to the motor is turned off, and the driving of the motor is released, and the denture brush 1 stops.

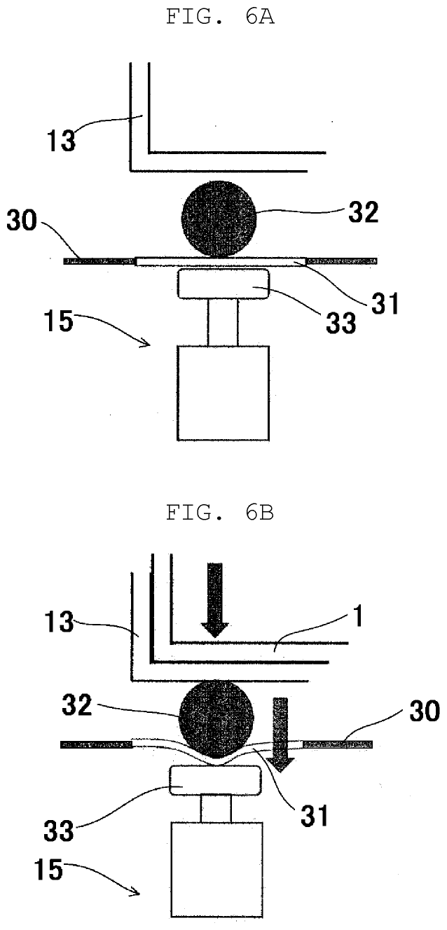

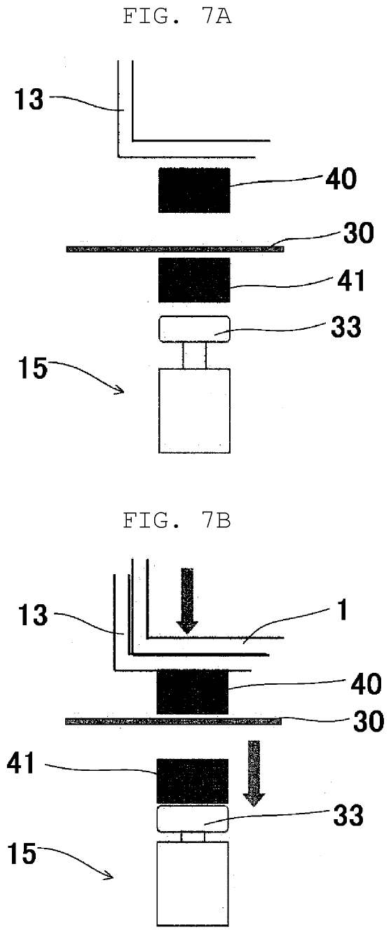

A detailed structure of the detection means mentioned above is shown in FIG. 6 and FIG. 7. FIG. 6A and FIG. 6B show a first embodiment of the detection means. As shown in FIG. 6A, the detection means includes the brush support 13 that bears the denture brush 1, an elastically deformable body 31 disposed above the switch 15, and a roller 32 disposed between the brush support 13 and the elastically deformable body 31. In the detection means shown in FIG. 6, the elastically deformable body 31 is attached to a part of an upper cover 30 that covers an upper part of the switch 15. Waterproof measures for a region under the upper cover 30 are taken by the upper cover 30, and the function of the switch is prevented from being impeded by moisture that has adhered to the denture brush 1. Herein, the term “above the switch 15” denotes that the elastically deformable body 31 is disposed above the switch 15 in a case in which the denture brusher is used while the holder 11 is being grasped with the hand as shown in FIG. 3A or in a case in which the denture brusher is used while the holder body 14 is being set in the support stand 16 as shown in FIG. 3B.

When a denture is set in the denture brush 1, the brush support 13 comes into contact with the roller 32, and the roller 32 presses the elastically deformable body 31 in a direction shown by the arrow, and, as a result, the elastically deformable body 31 is bent, and pushes a switch head 33, and the switch 15 is turned on as shown in FIG. 6B. Although a spherical roller can be used as the roller 32, the roller 32 may have another shape. Additionally, the elastically deformable body 31 is merely required to have the property of being elastically deformed by an external force and being restored to its original state when the external force is released, and a material having such a property can be appropriately selected as the forming material of the elastically deformable body 31.

On the other hand, when the denture is moved in a direction away from the denture brush 1, the brush support 13 is detached from the roller 32, and the roller 32 returns to the original position, and the elastically deformable body 31 is unbent, and as a result, the elastically deformable body 31 is detached from the switch head 33, and the switch 15 is turned off as shown in FIG. 6A.

FIG. 7A and FIG. 7B show a second embodiment of the detection means. As shown in FIG. 7A, the detection means includes the brush support 13 that bears the denture brush 1, a first magnet 40 disposed under the brush support 13, and a second magnet 41 disposed between the first magnet 40 and the switch 15. In the detection means shown in FIG. 7, the first magnet 40 is disposed between the upper cover 30 that covers the upper part of the switch 15 and the brush support 13, and the second magnet 41 is disposed between the upper cover 30 and the switch head 33. Herein, the term “under the brush support 13” denotes that the first magnet 40 is disposed under the brush support 13 in a case in which the denture brusher is used while the holder 11 is being grasped with the hand as shown in FIG. 3A or in a case in which the denture brusher is used while the holder body 14 is being set in the support stand 16 as shown in FIG. 3B.

The first magnet 40 and the second magnet 41 have magnetic properties of the same pole, and, when a denture is set in the denture brush 1, the brush support 13 comes into contact with the first magnet 40 as shown in FIG. 7B, and the first magnet 40 approaches the second magnet 41, and the second magnet 41 is moved by a repulsive force caused by a magnetic force of the first magnet 40 in a direction shown by the arrow and then pushes the switch head 33, and the switch 15 is turned on.

On the other hand, when the denture is moved in a direction away from the denture brush 1, the brush support 13 is detached from the first magnet 40, and the first magnet 40 returns to its original position, and, as a result, the first magnet 40 moves away from the second magnet 41, and the repulsive force against the second magnet 41 is released, and, as a result, the second magnet 41 is detached from the switch head 33 as shown in FIG. 7A, and the switch 15 is turned off. The magnetic force and the interval between the first magnet 40 and the second magnet 41 are set so that the aforementioned function of the detection means can be fulfilled.

The detection means and the switch operation mentioned above activate the denture brush 1 only when a denture is brushed by the denture brush 1, and, when the use of the denture brusher is finished, the denture brusher is automatically stopped, hence making it possible to brush the denture safely and reasonably. The configuration of the detection means mentioned above is one example, and a means having another configuration can be employed as the detection means.

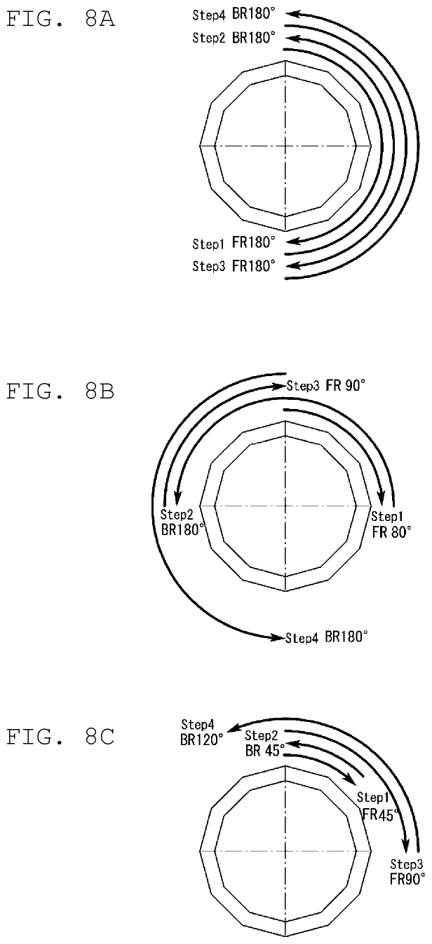

FIG. 8 shows rotation patterns of the denture brush 1. FIG. 8A shows a rotation pattern of large rotation in which normal rotation (“FR” in FIG. 8) is made 180 degrees from a starting point, and then reverse rotation (“BR” in FIG. 8) is made so as to return to the starting point. The repetition of this operation makes it possible to brush the whole region of a denture.

FIG. 8B shows a rotation pattern in which the large rotation and small rotation, which is defined as repetition of both the normal rotation and the reverse rotation under the condition that the rotation angle is less than 180 degrees, are combined together. In this case, the large rotation and the small rotation are appropriately combined together such that the normal rotation is made 90 degrees from the starting point, and then the reverse rotation is made 180 degrees, and the normal rotation is made 90 degrees from that position, and then the reverse rotation is made 180 degrees.

When switching is performed from the normal rotation to the reverse rotation, an operation to scrape out stains that have locally gathered is performed, and therefore it is possible to raise efficiency in scraping out stains per unit time by making the small rotation in which the normal rotation and the reverse rotation are repeatedly made at a small angle.

FIG. 8C shows another rotation pattern in which the large rotation and small rotation, which is defined as repetition of both the normal rotation and the reverse rotation under the condition that the rotation angle is less than 180 degrees, are combined together. In this case, the small rotation is made by displacing the switching position from the normal rotation to the reverse rotation such that the normal rotation is made 45 degrees from the starting point, and then the reverse rotation is made 45 degrees so as to return to the starting point, and the normal rotation is made 90 degrees from that position, and then the reverse rotation is made 120 degrees. Therefore, the switching position is set at mutually different positions.

When switching is performed from the normal rotation to the reverse rotation, an operation to scrape out stains that have locally gathered is performed, and therefore it is possible to raise efficiency in scraping out stains in the whole region by changing both the starting point in the small rotation and the switching position from the normal rotation to the reverse rotation in each rotation and by setting the small rotation so as to be repeatedly made in different intervals.

As thus described, in the denture brusher of the present invention, it is possible to set and configure the rotation pattern of the denture brush 1 by means of the motor such that the large rotation in which the normal rotation is made 180 degrees from the starting point and then the reverse rotation is made so as to return to the starting point is combined with the small rotation in which the normal rotation and the reverse rotation are repeatedly made under the condition that the rotation angle is less than 180 degrees.

It is possible to set the rotation angle in the rotation pattern of the denture brush 1 mentioned above by use of, for example, a stepping motor. Additionally, it is possible to apply the present invention such that some rotation patterns are pre-set in a mode setting manner, and a user selects a favorite mode.

As described above, the denture brush 1 of the present invention is capable of being used while being electrically driven and rotated in a state of being attached to the holder 11, and, in addition, is capable of manually brushing a denture by housing the denture brush 1 in a container and rotating the denture, which has been set in the denture brush 1, with the hand.

The present invention is widely applicable as a denture brusher that is capable of thoroughly brushing a denture in a short time by a simple operation, that is capable of being easily cleaned, and that is excellent in operability.

### REFERENCE SIGNS

1 Denture brush
2 Base
3 Wall piece
4 Frame
5 First bristle tufts
6 Second bristle tufts
7 Third bristle tufts
8 Void space
9 Through-hole
11 Holder
12 Denture-brush-housing portion
13 Brush support
14 Holder body
15 Switch
16 Support stand
21 Concave portion
22 Convex portion
23 Convex portion
24 Concave portion
30 Upper cover
31 Elastically deformable body
32 Roller
33 Switch head
40 First magnet
41 Second magnet

1. A denture brusher, comprising:
a denture brush;
a holder whose surface on a side opposite to a bottom of the holder is open and in which a bottomed denture-brush-housing portion that is capable of housing the denture brush is formed;
a motor that drives the denture brush by an on-off operation of a switch;
a detection means for detecting whether a denture that is a to-be-brushed part is set in the denture brush,
wherein the denture-brush-housing portion includes a bottom,
wherein, when the detection means detects that the denture has been set in the denture brush, the switch is turned on and the motor is driven,
wherein, when the detection means detects that the denture is not set in the denture brush, the switch is turned off and the motor stops being driven, and
wherein the denture brush includes:
a frame composed of a flat plate-shaped base and a plurality of wall pieces disposed at an outer circumferential part of the base;
first bristle tufts arrayed on the wall pieces;
second bristle tufts arrayed in a center region of the base; and
third bristle tufts arrayed on an outer circumferential side of the second bristle tufts and that has an openable/closable structure in which switching is performed between an open state in which the wall pieces are positioned radially along the outer circumferential part of the base so as to be horizontal with respect to the base and a closed state in which the wall pieces are positioned so as to stand upright with respect to the base.

2. The denture brusher according to claim 1, wherein the detection means includes:
a brush support that bears the denture brush;
an elastically deformable body disposed above the switch; and
a roller disposed between the brush support and the elastically deformable body,
wherein, when the denture is set in the denture brush so that the brush support comes into contact with the roller, the roller presses the elastically deformable body, which causes the elastically deformable body to bend, and pushes a switch head of the switch, which causes the switch to turn on, and,
wherein, when the brush support is detached from the roller, the roller returns to an original position so as to unbend the elastically deformable body, which causes the elastically deformable body to detached from the switch head and turn off the switch.

3. The denture brusher according to claim 1, wherein the detection means includes:
the brush support that bears the denture brush;
a first magnet disposed under the brush support; and
a second magnet disposed between the first magnet and the switch,
wherein the first magnet and the second magnet have magnetic properties of the same pole,
wherein, when the denture is set in the denture brush so that the brush support comes into contact with the first magnet, the first magnet approaches the second magnet and a repulsive force caused by a magnetic force of the first magnet causes the second magnet to push the switch head which turns on the switch, and
wherein, when the brush support is detached from the first magnet so that the first magnet returns to an original position, the first magnet moves away from the second magnet, and to release the repulsive force against the second magnet is, so that the second magnet is detached from the switch head which turns off the switch.

4. The denture brusher according to claim 1, wherein, when the denture brush is housed in the denture-brush-housing portion, a lower surface of the base of the denture brush comes into contact with an upper surface of the bottom of the denture-brush-housing portion, and
wherein a concave portion formed at the lower surface of the base of the denture brush and a convex portion formed at the upper surface of the bottom of the denture-brush-housing portion are fitted to each other.

5. The denture brusher according to claim 1, wherein, when the denture brush is housed in the denture-brush-housing portion, a lower surface of the base of the denture brush comes into contact with an upper surface of the bottom of the denture-brush-housing portion, and
wherein a convex portion formed at the lower surface of the base of the denture brush and a concave portion formed at the upper surface of the bottom of the denture-brush-housing portion are fitted to each other.

6. The denture brusher according to claim 1, wherein a rotation pattern of the denture brush is formed by the motor,
wherein the rotation pattern includes:
a large rotation that is a normal rotation is made 180 degrees from a starting point;
a reverse rotation that is made after the large rotation so as to return to the starting point; and
a small rotation in which the normal rotation and the reverse rotation are combined with each other and repeatedly ma with a rotation angle that is less than 180 degrees.

7. The denture brusher according to claim 6, wherein the small rotation is set to be repeatedly made in different intervals that displaces a switching position from the normal rotation to the reverse rotation such that the switching position is changed in each rotation.

8. The denture brusher according to claim 1, wherein the holder is supported and fixed by a support stand.
